(19) United States
(12) Patent Application Publication
(10) Pub. No.: US 2024/0354061 A1
(43) Pub. Date: Oct. 24, 2024

(54) PLL Based Bit Rate Efficient Random Number Generator

(71) Applicant: Bradford T Hite, Valencia, CA (US)

(72) Inventor: Bradford T Hite, Valencia, CA (US)

(21) Appl. No.: 18/305,341

(22) Filed: Apr. 22, 2023

(51) Int. Cl. G06F 7/58

(52) U.S. Cl. CPC G06F 7/588

(57) ABSTRACT

An improved bit rate efficient random number generators (RNG) based on a phase lock loop (PLL) circuit is described. The invention is configured to provide a high quality random number statistical distribution at the reference clock rate. This ability to create a random serial data stream at the reference clock rate eliminates high frequency clocks required by other RNG implementations thereby reducing power consumption. The random sequence serial data stream allows a unique random number to be generated each reference clock cycle by accumulation into an N-Bit shift register. Example schematics and performance simulations are presented to establish numerical statistics.

### CROSS-REFERENCES TO RELATED APPLICATIONS

Not Applicable.

### STATEMENT REGARDING FEDERALLY SPONSORED RESEARCH OR DEVELOPMENT

Not Applicable.

### REFERENCE APPENDICES

Not Applicable

### BACKGROUND OF THE INVENTION

### 1. Field of the Invention

This invention relates to the field of bit rate efficient random number generators (RNG) based on a phase lock loop (PLL) circuit. The present invention describes an improvement over prior art with respect to the generated random number statistical distribution. Additionally, improvements are described for simplifying RNG usability and output signal stability. These improvements are achieved by changes to the electrical connection arrangement and introduction of a dead band into the PLL circuit such that internal oscillator phase noise generates uniformly distributed random numbers formed into a clocked serial data stream. The random sequence serial data stream allows a unique random number to be generated each reference clock cycle by accumulation into an N-Bit shift register.

### 2. Description of the Related Art

There are many commonly known digital methods for generating a stream of random numbers found in the literature. These digital methods are preferred to electrical analog, quantum or radioactivity processes due to the ability for integration within an ASIC device. One of the first digital implementations is referred to as the Intel Random Number Generator wherein two clock signals in combination with thermal noise served to produce a random sequence. Most methods involve the combination of free running oscillators each having a characteristic timing jitter to produce a random sequence. Another recent method involves the usage of multiple PLL circuits to generate clock signals containing timing jitter whereby the clock frequency relationship is adjusted to maximize random sampling. All of these methods require high clock frequencies to generate a lower rate random number sequence increasing the required power consumption.

The combination of multiple free running oscillator signals used to produce a random sequence has been studied by multiple authors. Intel produced one of the first digital RNG implementations by high speed sampling of a thermally modulated VCO. Another dual oscillator RNG configuration was proposed by Tkacik utilized two XOR combined linear feedback shift registers (LFSR) with inherent timing jitter. Further dual oscillator digital implementations have been proposed with alterations to LFSR topology and numerical table driven feedback methods. Finally, the dual oscillator concept was expanded to include multiple rate oscillators with XOR combining prior to sampling. All of these oscillator methods typically operate with clock frequency rates greater than 10-times the effective random sequence bit rate.

PLL based generation of random sequences has been recently studied by Fischer and Drutarovsky based on clock jitter sampling. Their method utilizes a dual PLL approach to produce two harmonically related clock frequencies designed to maximize transition zone jitter sampling. In one approach, the first clock is XORed with the second and down sampled using a decimator. A second configuration has the first clock sampled by the second and decimated to generate the random sequence. The random sequence bit rate is described to be 70 Kbits/s using a reference clock frequency of 40 MHz.

A single PLL based RNG has been described in patent US2009/0327380 titled “Circuit and Method of Generating a Random Number using a Phase-Locked-Loop Circuit” (abandoned). This implementation utilizes a PLL circuit containing a noise generating VCO to generate a random clock signal used to sample the reference signal. The concept is similar to the present invention however improvements are described herein for obtaining a usable stable random number distribution as required for cryptology applications. These improvements are demonstrated by comparison of simulation models for the prior art circuit and present invention circuit. Specifically, the prior art circuit suffers from three problem aspects improved upon by the present invention. First, the generated RNG output distribution is not uniform across the operating range and skewed from the required flat response. Second, the PLL output sampling D flip-flop 1200 in prior art FIG. 1000 cannot produce constant fixed frequency rate of a random number data stream making use of the circuit extremely difficult. Third, the PLL output sampling D flip-flop 1200 in prior art FIG. 1000 is subject to metastability conditions encountered by sampling a random signal.

### BRIEF SUMMARY OF THE INVENTION

The present invention comprises an improved PLL based random number generator providing a well defined random statistical distribution. Additional improvements include changes to the noise modulated frequency signal sampling method to improve stability of the numerical serial data stream. The RNG implementation is based on a standard PLL circuit with a multiplication ratio of one whereby the VCO frequency output is configured to contain high noise content. This VCO generated high noise frequency signal is sampled by a flip-flop clocked by the PLL reference clock frequency. Conceptually, a random bit stream can be generated at the reference clock frequency rate eliminating the need for high frequency clocks associated with other RNG topologies. The elimination of high frequency clocks greatly reduces the power consumption necessary to generate a high bit rate data stream.

Three improvements provided by present invention are described herein to the prior art circuit affecting stability and output statistics. First, in order to address the non uniform RNG distribution aspect the PLL phase frequency detector is modified to add a dead band time delay to effectively flatten out the random number distribution. Second, in addressing the fixed rate data stream the PLL output sampling D flip-flop is modified to swap the random clock (CK) input signal with the reference clock (D) input. Swapping of these signals enables a constant fixed frequency rate of random number outputs based on the reference clock frequency capable of input to a serial shift register. Having the sample clock based on a random interval makes conversion of the serial data stream into parallel representation unstable. Finally, the present invention adds an additional synchronization flip-flop after the PLL output sampling D flip-flop to solve any metastability issues encountered by sampling a random signal. These three described improvements will enable the present invention to operate as a usable RNG.

### BRIEF DESCRIPTION OF THE DRAWINGS

FIG. 1 is a system block diagram showing the various components of the present invention.

FIG. 2 is a schematic showing the electrical blocks and signal flow between blocks to implement an example conventional PLL circuit design.

FIG. 3 is a schematic showing the electrical blocks and signal flow between block to implement the modified RNG PLL circuit design.

FIG. 4 is electrical simulation (SPICE) modeling showing frequency domain operation of the schematic circuit from FIG. 2.

FIG. 5 is electrical simulation (SPICE) modeling showing frequency domain operation of the schematic circuit from FIG. 3.

FIG. 6 is a simulation model (MATLAB) to generate a histogram showing the numerical distribution of values produced by the circuit in FIG. 2.

FIG. 7 is a simulation model (MATLAB) to generate a histogram showing the numerical distribution of values produced by the circuit in FIG. 3 modified only with increased VCO tuning gain.

FIG. 8 is a simulation model (MATLAB) to generate a histogram showing the numerical distribution of values produced by the circuit is FIG. 3 modified with both increased VCO tuning gain and PLL dead band.

FIG. 9 is the MATLAB source code used to generate a histogram numerical distribution display based on SPICE simulation outputs.

### REFERENCE NUMERALS IN THE DRAWINGS

| | | | |
|---|---|---|---|
| 100 | PLL reference | 102 | PLL phase frequency |
| | oscillator | | detector |
| 104 | PLL dead band time | 106 | PLL charge pump and loop |
| | delay | | filter |
| 108 | VCO tuning gain block | 110 | VCO phase noise source |
| 112 | PLL VCO block | 114 | Sampling D flip-flop |
| 116 | Synchronization | 118 | N-bit serial shift register |
| | D flip-flop | | outputting a parallel value |
| 200 | PLL circuit reference | 202 | PLL circuit phase |
| | oscillator | | frequency detector |
| 204 | PLL circuit dead band | 206 | PLL circuit charge pump |
| | time delay with | | and loop filter |
| | parameter | | |
| 208 | PLL circuit phase noise | 210 | PLL circuit VCO with tuning |
| | source | | gain parameters |
| 212 | Sampling circuit | | |
| 300 | Modified PLL circuit | 302 | Modified PLL circuit dead |
| | VCO with tuning gain | | band time delay with |
| | parameters | | parameter |

### DETAILED DESCRIPTION OF THE INVENTION

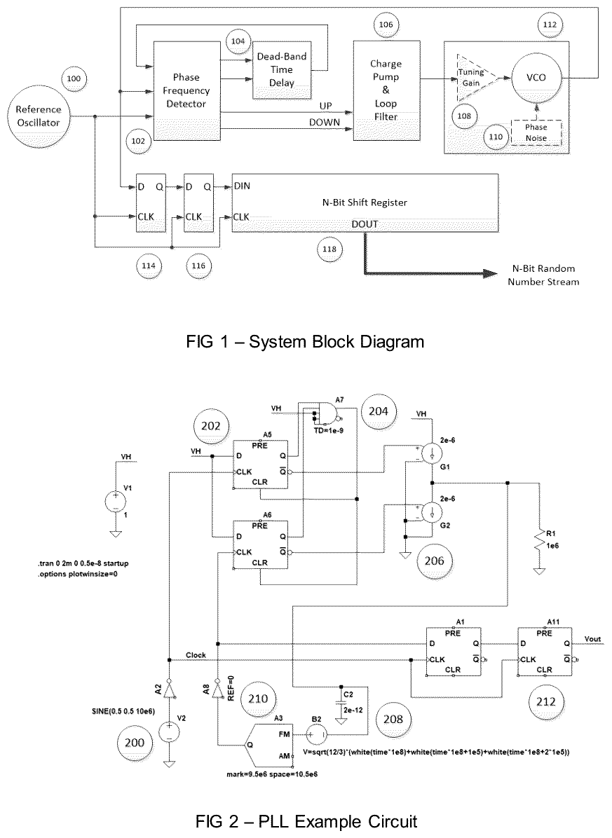

The present invention is detailed in system block diagram FIG. 1 showing functional components and signal interconnects. FIG. 1 details the present invention as a modified PLL capable of synchronizing an internally generated frequency signal with a reference signal. Reference Oscillator 100 provides an input clock frequency for controlling the rate of random number generation. Phase Frequency Detector 102 compares the reference frequency and VCO generated output frequency to determine the phase frequency state and modulate up-down charge pump control signal outputs. Dead Band Time Delay 104 is used to delay the reset signal to Phase Frequency Detector 102 thereby creating an effective operating dead band. A standard PLL implementation would not contain an intentionally created dead band since it serves to degenerate the loop performance. Charge Pump & Loop Filter 106 takes the up-down control signals and generates an integrated VCO control voltage. VCO 112 contains internal operating parameters Tuning Gain 108 and Phase Noise 110 being determined by the electrical design. Tuning Gain 108 provides a transfer function between the VCO input control voltage and oscillator tunable frequency range. Phase Noise 110 represents the internal random noise present in the oscillator output signal. VCO 112 provides an output frequency consisting of the desired frequency per the input control voltage and random phase noise component. Sampling Flip-Flop 114 clocks in the value of VCO 112 output present based on the reference clock. Synchronization Flip-Flop 116 re-clocks Sampling Flip-Flop 114 output thereby preventing a metastability condition. Shift Register 118 holds the last N-Bit values of Synchronization Flip-Flop 116 providing a parallel N-Bit numerical output at the reference clock frequency.

FIG. 2 shows an example schematic representation embodiment of the present invention configured as a standard phase locked PLL having a multiplication ratio of one. This circuit topology is similar to what is described in the prior art thereby having representative performance. Operating in a phased locked state will produce a narrow band frequency output equal to the reference clock input. Added noise contribution in the VCO output frequency necessary to generate a random sequence will be modeled by increasing the VCO tuning gain. Reference Oscillator 200 provides an input frequency for controlling the rate of random number generation. Phase Frequency Detector 202 compares the reference frequency and VCO output to determine phasing state and modulate up-down charge pump control signal outputs. Dead Band Time Delay 204 is used to delay the reset signal to Phase Frequency Detector 202 thereby creating an operating dead band. Charge Pump & Loop Filter 206 takes the up-down control signals and outputs a current signal. The loop filter is designed for low pass filtering of the current signal to generate an integrated VCO control voltage. VCO 210 contains internal operating parameters for inherent Tuning Gain and Phase Noise Source 208 being determined by the electrical design. The Tuning Gain provides a transfer function between the VCO input control voltage and oscillator tunable frequency range. Phase Noise 208 represents the internal noise present in the oscillator output signal. VCO 210 provides an output frequency consisting of the desired frequency per the input control voltage and phase noise component. Sampling Flip-Flop 212 clocks in the value of VCO 210 output present based on the reference clock. Utilization of the reference clock for VCO signal sampling is one improvement provided by the present invention. Synchronization Flip-Flop 212 re-clocks Sampling Flip-Flop 212 output thereby preventing a metastability condition. The shift register as connected to Vout holds the last N-Bit values of Synchronization Flip-Flop 212 providing a parallel N-Bit numerical output.

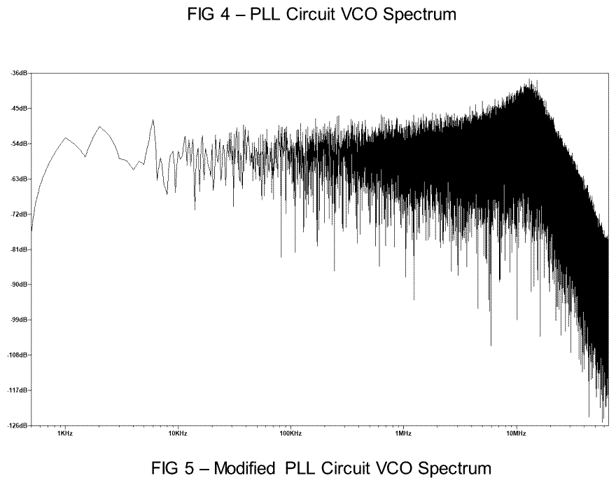

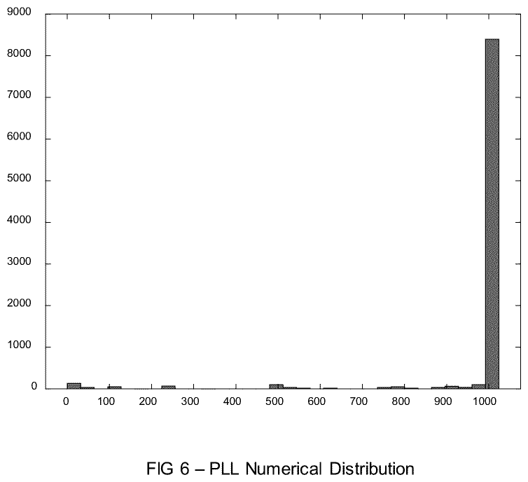

FIG. 4 shows an electrical simulation of the VCO output spectrum of the FIG. 2 phase locked reference example. It can be seen the PLL compensated VCO output frequency is locked to the 10 MHz reference frequency. In this simulation, the PLL is modeled with a low noise VCO having a tuning range of 1 MHz and no introduced dead band. FIG. 6 shows a histogram distribution of the random numbers generated by the output shift register for a 10 bit numerical representation. Since the PLL is operating in a phase locked condition, the VCO output signal is constantly sampled in the high state as indicated by the histogram.

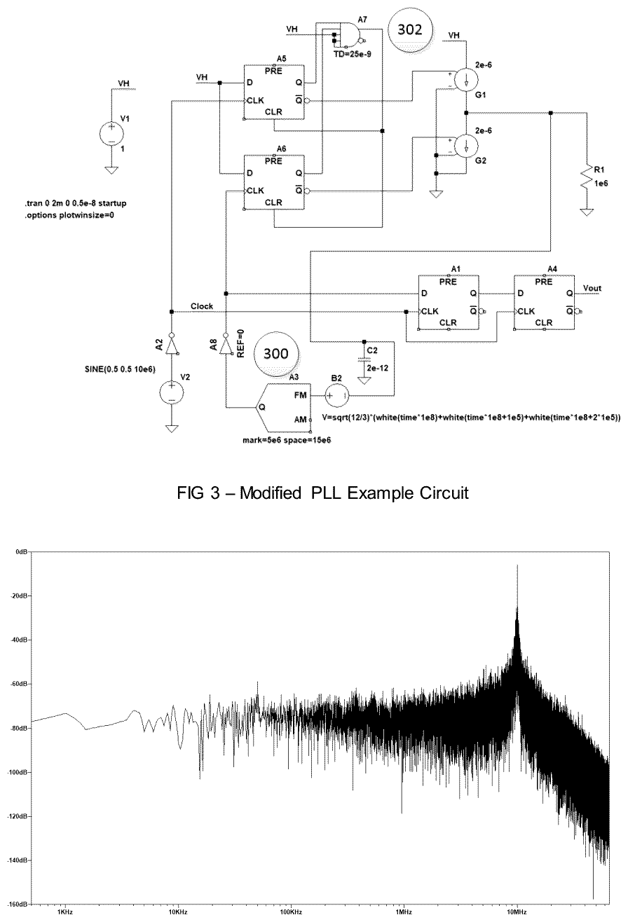

The preferred embodiment of the invention is shown in FIG. 3 as a modified example schematic of FIG. 2 necessary to implement the improved RNG. All of the prior description provided for FIG. 2 is applicable to this preferred embodiment as modified below. In this preferred embodiment, Dead Band Time Delay 302 is modified to have a fixed propagation delay of 25 nS thereby implementing a PLL dead band. Additionally, VCO 300 is modified to include a random noise component thru increasing the tuning gain to operate over a 10 MHz range. Any Low-Q oscillator type with the capability of a large tuning range can be used to implement VCO 300. An example would be a phase shift oscillator or inverter ring commonly used in integrated circuits.

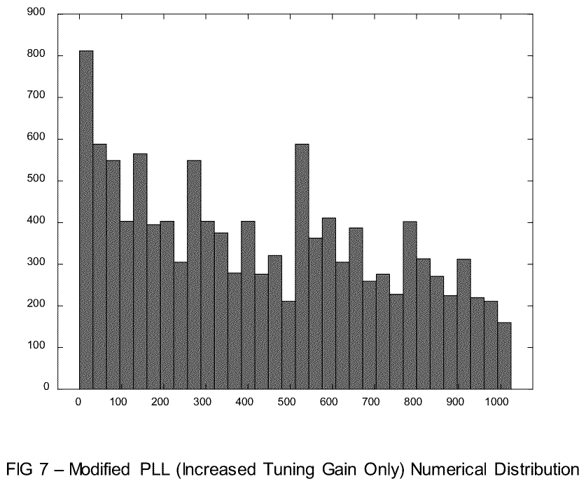

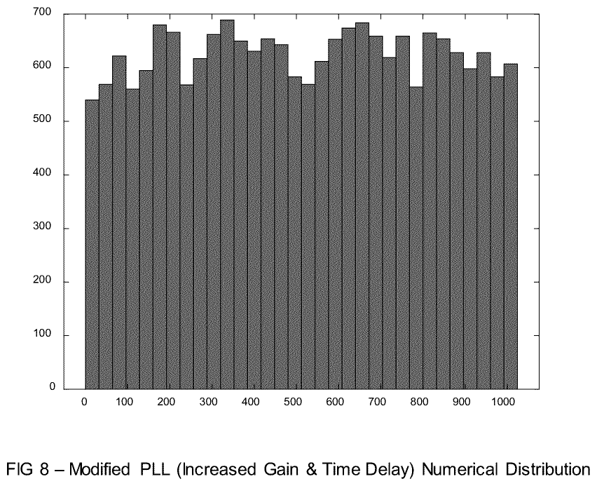

FIG. 5 shows an electrical simulation of the FIG. 3 preferred embodiment circuit whereby the PLL compensated VCO output spectrum is now dominated by a phase noise component. This phase noise component becomes dominate by increasing the effective VCO tuning gain. To demonstrate the improved performance of the present invention over prior art, FIG. 7 details a histogram distribution of the random numbers generated by the 10 bit output shift register whereby the FIG. 3 circuit configuration has been modified to remove the effects of Dead Band Time Delay 302. It can be seen the distribution of random numbers generated is skewed towards lower numeric values having a non uniform response as opposed to a flat response having an equal count for each histogram bin. This distribution, as produced by the prior art configuration, does not represent a useful RNG function since ideally a flat equal response is required for each histogram bin. FIG. 8 details a histogram distribution of the random numbers generated by the 10 bit output shift register for the preferred embodiment circuit configuration having both an increased VCO tuning gain and dead band timing introduction per FIG. 3. The resultant distribution is now statistically flat across all histogram bins having acceptable performance for the RNG.

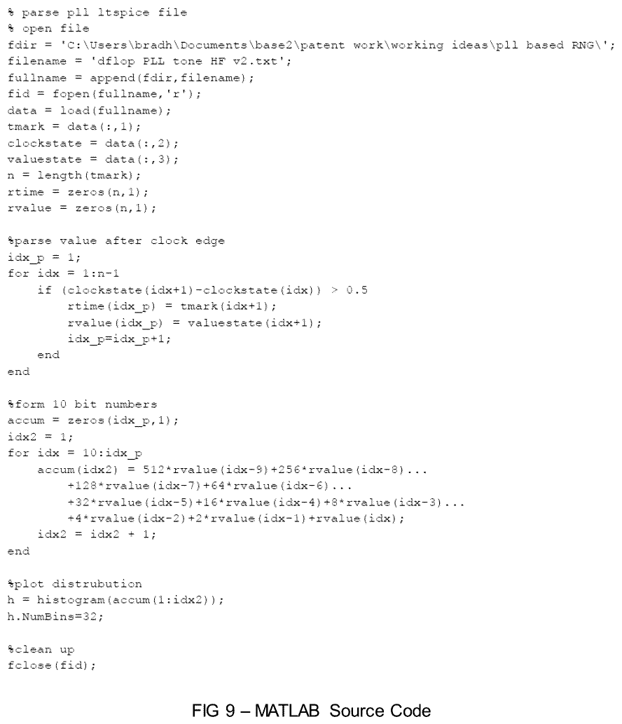

FIG. 9 details MATLAB source code for the program used to generate each histogram diagram. Numeric representation is fixed at 10-bits with the number histogram bins set to a power of two being 32 for all cases. Larger parallel bit field widths for random number output can be implemented simply by increasing the number of flip-flops in the output shift register.

I claim:

1. A circuit for generating a random number comprising:
a. A phase-locked loop circuit configured to generate an internal frequency signal synchronized with a reference clock signal, the internal frequency signal having a random noise; and
b. a sampling circuit configured to sample the internal frequency signal in response to the reference clock signal to generate a random data bit.

2. The circuit of claim 1, wherein the phase-locked loop circuit contains a dead band time delay.

3. The circuit of claim 1, wherein the sampling circuit comprises a first sampling D flip-flop followed by a second synchronization D flip-flop.

4. The circuit of claim 1, further comprising an N-bit length shift register coupled to the sampling circuit, the N-bit length shift register generating a parallel N-bit random data stream in response to the sampling circuit.

5. The circuit of claim 1, wherein the phase-locked loop circuit comprises:
a. a phase-frequency detector configured to generate an up signal and a down signal by detecting a phase difference between the internal frequency signal and the reference clock signal;
b. a charge pump configured to generate a current signal in response to the up signal and the down signal;
c. a loop filter configured to pass a low frequency of the current signal to generate a control voltage; and
d. a voltage-controlled oscillator configured to generate random noise, and configured to generate the internal frequency signal having a variable frequency in response to the random noise and the control voltage.

6. A method of generating a random number comprising:
a. generating an internal frequency signal synchronized with a reference clock signal, the internal frequency signal having a random noise component, and;
b. sampling the internal frequency signal in response to the reference clock signal to generate a random data bit.

7. The method of claim 6, further comprising generating a PLL dead band by time delay of phase frequency detector signals.

8. The method of claim 6, further comprising sampling of the random data bit by a first sampling D flip-flop and a second synchronization D flip-flop.

9. The method of claim 6, further comprising generating a parallel N-bit random data stream using an N-bit shift register.

10. The method of claim 6, wherein generating the internal frequency signal comprises:
a. generating an up signal and a down signal by detecting a phase difference between a internal frequency signal and the reference clock signal;
b. generating a current signal in response to the up signal and the down signal;
c. passing a low frequency of the current signal to generate a control voltage;
d. generating the random noise; and
e. generating the internal frequency signal having a variable frequency in response to the random noise and the control voltage.
